(19) United States
(12) Patent Application Publication
(10) Pub. No.: US 2002/0069136 A1
(43) Pub. Date: Jun. 6, 2002

(54) Network-based method and system for configuring automatic transfer switches

(76) Inventors: Alex Lombardi, Marlborough, CT (US); Hawkins Cui, Middletown, CT (US); David Merritt, Avon, CT (US); Linda Phillips, Tinley Park, IL (US); Thomas S. Ferry, New Lenox, IL (US)

Correspondence Address: John S. Beulick, Armstrong Teasdale LLP, Suite 2600, One Metropolitan Sq, St. Louis, MO, 63102, US

(21) Appl. No.: 09/729,875

(22) Filed: Dec. 5, 2000

(51) Int. Cl. G06F 17/60

(52) U.S. Cl. 705/27

(57) ABSTRACT

A network-based method for configuring automatic transfer switches includes receiving automatic transfer switch specification information from a user and using a server to compare the received specification information with pre-stored information. The method also includes selecting at least one automatic transfer switch that matches the received specification information and displaying to the user information related to the automatic transfer switch. A network-based method also provides for selection of a various accessories for the selected automatic transfer switch.

### BACKGROUND OF THE INVENTION

This invention relates generally to computer network-based systems and more particularly to a network-based method and system for configuring automatic transfer switches.

Automatic transfer switches are used in electric equipment and machinery, but identifying a correct automatic transfer switch for a specific application is not always an easy task. Many parameters should be considered, and each combination of parameters could demand a specific transformer for optimum performance.

Therefore, it would be desirable to quickly determine a proper transformer that should be used for different combinations of parameters. In addition, it would be desirable to determine if a particular transformer provides inadequate performance for equipment, machinery, or a facility.

### BRIEF SUMMARY OF THE INVENTION

In an exemplary embodiment, an automatic transfer switch selection system allows users to select the most appropriate automatic transfer switch for their application needs over the Internet. The system guides a web user to answer several pre-arranged questions interactively about the product attributes and then uses those inputs to direct the user to a uniquely configured product having a specific catalog number. If the user's input combination results in an invalid configuration, the user receives messaging to guide the user to a valid alternative. The system allows both experienced and novice users to place orders directly for an automatic transfer switch through use of the Internet.

The network-based method for selecting a correct automatic transfer switch includes receiving product specification information from a user and comparing the received product specification information with pre-stored automatic transfer switch information. If at least one automatic transfer switch matches the received user criteria for the automatic transfer switch, the pre-stored automatic transfer switch information is downloaded for communication to the user.

The product information may include, for example, features of the product and accessories of the product. The method further includes validating configuration compatibility based on product information data and features of the product to determine whether a resulting product is capable of desired performance for a set of given product parameters.

### BRIEF DESCRIPTION OF THE DRAWINGS

FIG. 1 is a block diagram of a system in accordance with one embodiment of the present invention;

FIG. 2 is an expanded version block diagram of an exemplary embodiment of a server architecture of an alternative system;

FIG. 3 is a flow diagram of a network-based method for configuring automatic transfer switches;

FIG. 4 is an exemplary embodiment of an Automatic Transfer Switch main page that includes a plurality of links to be used when supplying information to the system shown in FIG. 3;

FIG. 5 is an exemplary embodiment of an Automatic Transfer Switch help page;

FIG. 6 is an exemplary embodiment of an Automatic Transfer Switch basic requirements page for pre-engineered swtiches for industrial/commercial use;

FIG. 7 is an exemplary embodiment of an Automatic Transfer Switch optional features page for pre-engineered swtiches for industrial/commercial use;

FIG. 8 is an exemplary embodiment of an Automatic Transfer Switch quick quote page for pre-engineered swtiches for industrial/commercial use;

FIG. 9 is a second exemplary embodiment of an Automatic Transfer Switch quick quote page;

FIG. 10 is a continuation page of a second exemplary embodiment of an Automatic Transfer Switch quick quote page;

FIG. 11 is an exemplary embodiment of a an Automatic Transfer Switch Residential/Commercial Light Use basic requirements page;

FIG. 12 is an exemplary embodiment of an Automatic Transfer Switch Residential/Commercial Light Use optional features page;

FIG. 13 is an exemplary embodiment of an Automatic Transfer Switch Residential/Commercial Light Use time delay settings page; and

FIG. 14 is an exemplary embodiment of an Automatic Transfer Switch Bill of Material page.

### DETAILED DESCRIPTION OF THE INVENTION

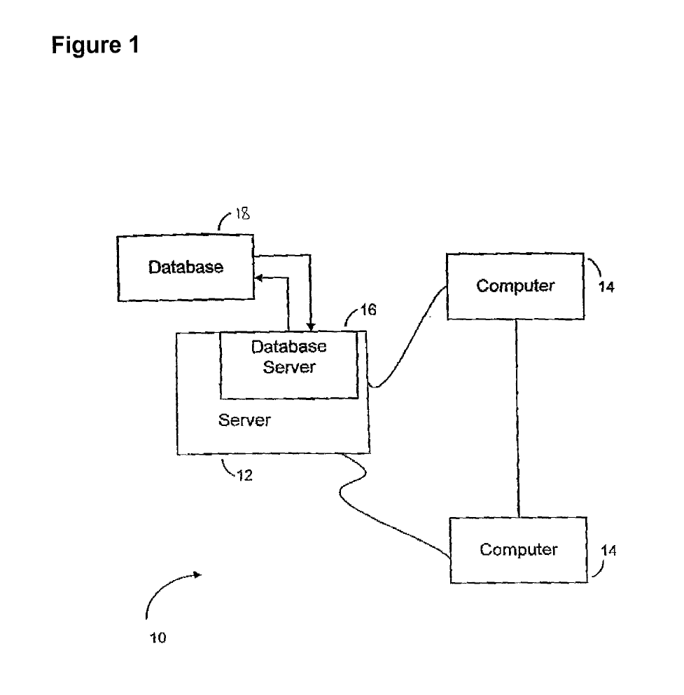

FIG. 1 is a block diagram of a system 10 in accordance with one embodiment of the present invention. System 10 includes a server sub-system 12, sometimes referred to herein as server 12, and a plurality of user devices 14 connected to server 12. In one embodiment, devices 14 are computers including a web browser, and server 12 is accessible to devices 14 via a network such as an intranet or the Internet. In an alternative embodiment, devices 14 are servers for a network of customer devices.

Devices 14 are interconnected to the network, such as a local area network (LAN) or a wide area network (WAN), through many interfaces including dial-in-connections, cable modems and high-speed ISDN lines. Alternatively, devices 14 are any device capable of interconnecting to a network including a network-based phone or other network-based connectable equipment. Server 12 includes a database server 16 connected to a centralized database 18 containing automatic transfer switch information. In one embodiment, centralized database 18 is stored on database server 16 and can be accessed by potential users at one of user devices 14 by logging onto server sub-system 12 through one of user devices 14. In an alternative embodiment centralized database 18 is stored remotely from server 12.

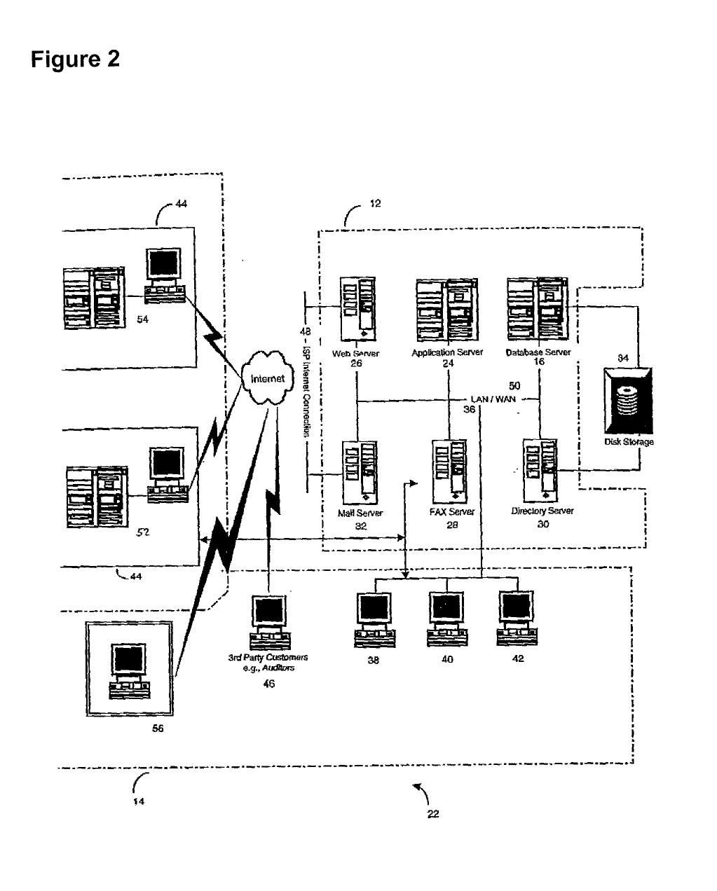

FIG. 2 is an expanded version block diagram of an exemplary embodiment of a server architecture of a system 22. System 22 includes server subsystem 12 and user devices 14. Server sub-system 12 includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator workstation 38, a user workstation 40, and a supervisor workstation 42 are coupled to LAN 36. Alternatively, workstations 38, 40, and 42 are coupled to LAN 36 via an Internet link or are connected through an intranet.

Each workstation 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

In another embodiment, server sub-system 12 is configured to be communicatively coupled to various individuals or employees 44 and to third parties, e.g., users, 46 via an ISP Internet connection 48. The communication in the exemplary embodiment is illustrated as being performed via the Internet, however, any other wide area network (WAN) type communication can be used in other embodiments, i.e., the systems and processes are not limited to being practiced via the Internet. In addition, and rather than a WAN 50, local area network 36 could be used in place of WAN 50.

In the exemplary embodiment, any employee 44 or user 46 having a workstation 52 can access server sub-system 12. One of user devices 14 includes a workstation 54 located at a remote location. Workstations 52 and 54 are personal computers having a web browser. Also, workstations 52 and 54 are configured to communicate with server sub-system 12. Furthermore, fax server 28 communicates with employees 44 and users 46 located outside the business entity and any of the remotely located user systems, including a user system 56 via a telephone link. Fax server 28 is configured to communicate with other workstations 38, 40, and 42 as well.

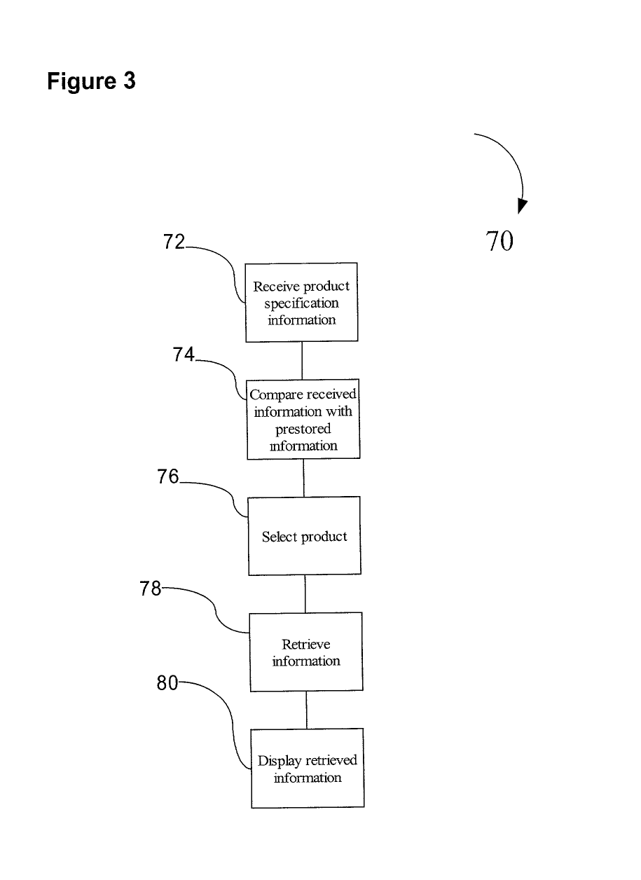

FIG. 3 is a flow diagram 70 for a network-based method for configuring automatic transfer switches. In one embodiment, the automatic transfer switch selection involves selection of direct-on-line automatic transfer switches. System 10 (shown in FIG. 1) receives 72 product specification information from a user. In one embodiment, the user inputs the information into a device (such as device 14 shown in FIG. 1) that transmits the information to a server (such as server 12 shown in FIG. 1). The product specification information is received from the user via a graphical user interface as will be described in greater detail below.

Server 12 compares 74 the received automatic transfer switch related requirements to pre-stored information accessible by server 12. In one embodiment, the pre-stored information is stored in a database that resides on server 12. In an alternative embodiment, the pre-stored information is stored in a database remote from server 12. The pre-stored information includes various types and configurations of automatic transfer switch related information. Server 12 compares the user provided information to the pre-stored information to determine if any pre-stored automatic transfer switch information contained in the database satisfy the product specifications/requirements submitted by the user.

In addition, server system 12 assesses the information supplied by the user to validate configuration compatibility of the product. Exemplary information includes product application, product parameters, desired product features, and product accessories. System 10 evaluates the information supplied by the user and determines whether a resulting product incorporating an automatic transfer switch having the received product specifications is capable of meeting parameters of the indicated product. For example, system 10 determines whether a selected automatic transfer switch with a given requirement is available to satisfy the user, and, if the selected automatic transfer switch with a given requirement is not available, system 10 displays a message to the user that the automatic transfer switch with the required product characteristics is not available and that the user should select an alternative product. In summary, system 10 reviews the user input and based on a pre-determined automatic transfer switch configuration as well as operating specifications, the user is provided feedback for a specific automatic transfer switch that meets the criteria for user application.

If the product resulting from the received information does not meet the parameters of the product, system 10 guides a user by providing suggestions for a correct product configuration. In an alternative embodiment, system 10 guides a user by providing information regarding alternative products compatible with the product parameters supplied by the user. In a further alternative embodiment, system 10 guides a user by providing information regarding products that are upgrades for the product parameters supplied by the user.

System 10 then identifies pre-stored automatic transfer switch information that matches the information entered by the user and selects 76 automatic transfer switch configurations from the pre-stored information. System 10 retrieves 78 information pertaining to the selected automatic transfer switch configuration. In one embodiment, the automatic transfer switch information includes an automatic transfer switch identifier number and associated price for each selected automatic transfer switch configuration. For example, the automatic transfer switch identifier number is a catalog number and the price is a list price of the product. Server 12 then transmits the retrieved identifier number and associated price and downloads the retrieved automatic transfer switch information to user device 14 for display 80 so that the user can view the information. In an alternative embodiment, system 10 uses the list price information to generate a quotation for each selected automatic transfer switch configuration including the indicated features and accessories and server 12 then transmits the retrieved automatic transfer switch identifier number and the quotation to user device 14.

System 10 then prompts the user to order one or more of the selected products. If the user is a registered user, system 10 accepts orders online by providing the user a purchase order form and receiving the completed purchase order form from the user. The completed purchase order form is then authenticated against predetermined criteria to determine whether system 10 should accept the completed purchase order form. If the purchase order form is accepted, the ordered product is then shipped to the user.

If the user is an unregistered user, and the user attempts to order a selected product, system 10 transmits a notification to the user indicating that a sales person or an authorized distributor will contact the user to confirm the order request. System 10 then transmits a notification, such as via email, to a selected person. The selected person then checks the order and instructs system 10 to transmit the order to a field sales regional manager or district manager. The field sales manager then follows-up with the lead or forwards the lead to a distributor with instructions to follow-up with the user that submitted the order.

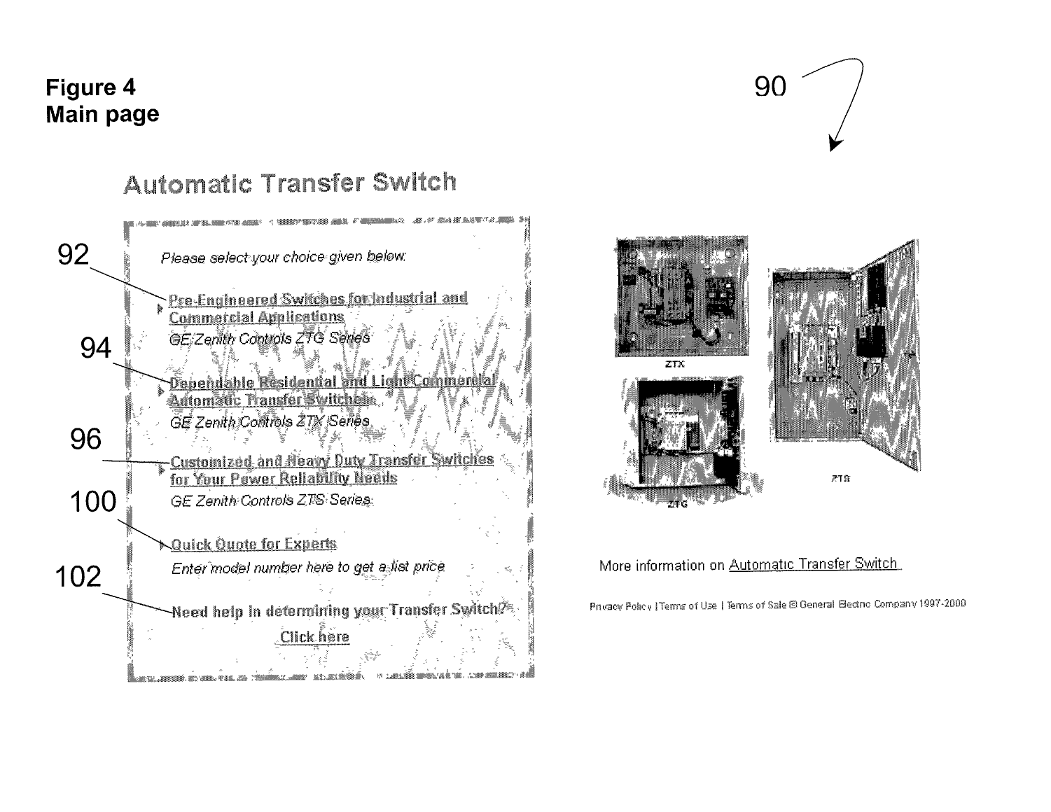

FIG. 4 shows an exemplary embodiment of an Automatic Transfer Switch main page, as depicted in screen shot 90. Screen shot 90 includes a Pre-Engineered Switches for Industrial/Commercial Applications link 92, a Dependable Residential and Light Commercial Automatic Transfer Switches link 94, a Customized and Heavy-Duty Transfer Switches for Your Power Reliability Needs link 96, a Quick Quote for Experts link 100, and a Help link 102.

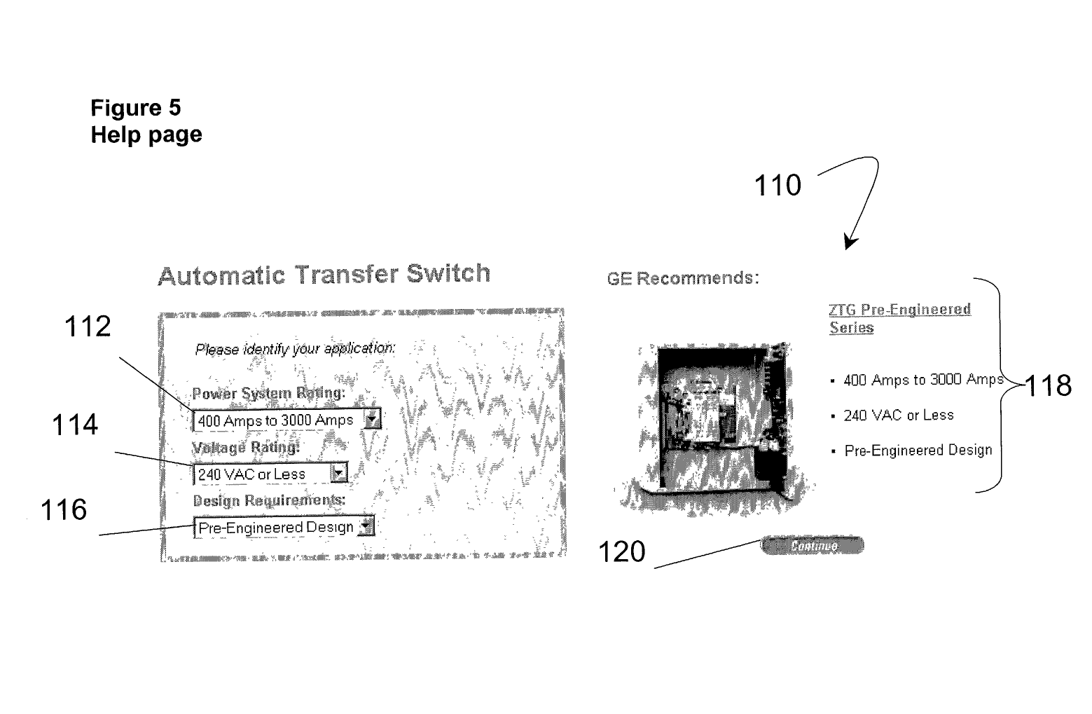

FIG. 5 shows an exemplary embodiment of an Automatic Transfer Switch help page, as depicted in screen shot 110. Screen shot 110 includes a Power System Rating pull down menu 112 for specifying a power system rating, a Voltage Rating pull down menu 114 for specifying a voltage rating, and a Design Requirements pull down menu 116 for specifying a design requirement. Screen shot 110 also includes a recommendation display area 118 that displays information about a recommended automatic transfer switch, and a Continue radio button 120.

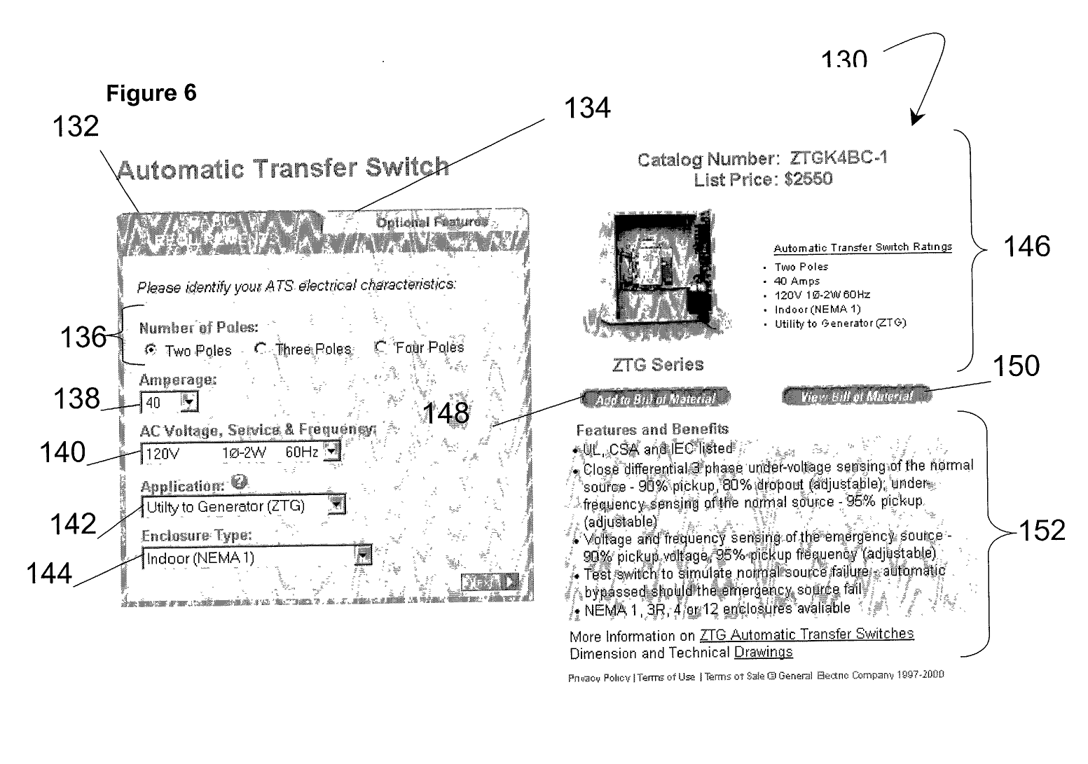

FIG. 6 shows an exemplary embodiment of an Automatic Transfer Switch basic requirements page for pre-engineered swtiches for industrial/commercial use, as depicted in screen shot 130. Screen shot 130 includes a Basic Requirements tab 132, and an Optional Features tab 134. Screen shot 130 results from selection of Basic Requirements tab 132, an includes a Number of Poles selection area 136, for specifying a number of poles, an Amperage pull down menu 138, an AC Voltage, Service & Frequency pull down menu 140, an Application pull down menu 142, and an Enclosure Type pull down menu 144. Screen shot 130 also includes a recommendation area 146, that in one embodiment includes a catalog number and a list price, and an Add to Bill of Material radio button 148 as well as a View Bill of Material radio button 150. Screen shot 130 also includes a Features and Benefits display area 152.

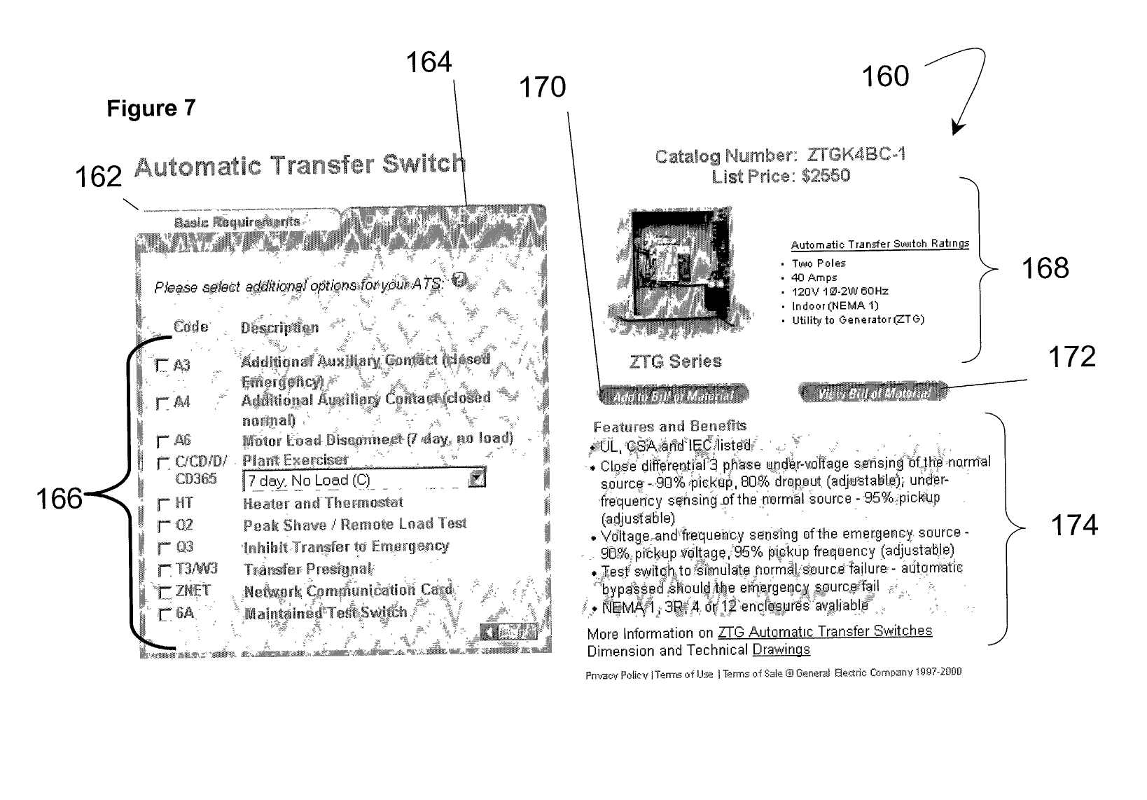

FIG. 7 shows an exemplary embodiment of an Automatic Transfer Switch optional features page for pre-engineered swtiches for industrial/commercial use, as depicted in screen shot 160. Screen shot 160 includes a Basic Requirements tab 162, and an Optional Features tab 164. Screen shot 160 results from selection of Optional Features tab 164, and includes an option selection area 166 that has a plurality of check boxes and pull down menus for specifying options for an automatic transfer switch. Screen shot 160 also includes a recommendation area 168, that in one embodiment includes a catalog number and a list price of a recommended product, as well as an Add to Bill of Material radio button 170 and a View Bill of Material radio button 172. Screen shot 160 further includes a Features and Benefits display area 174 to displace further information about their recommended product.

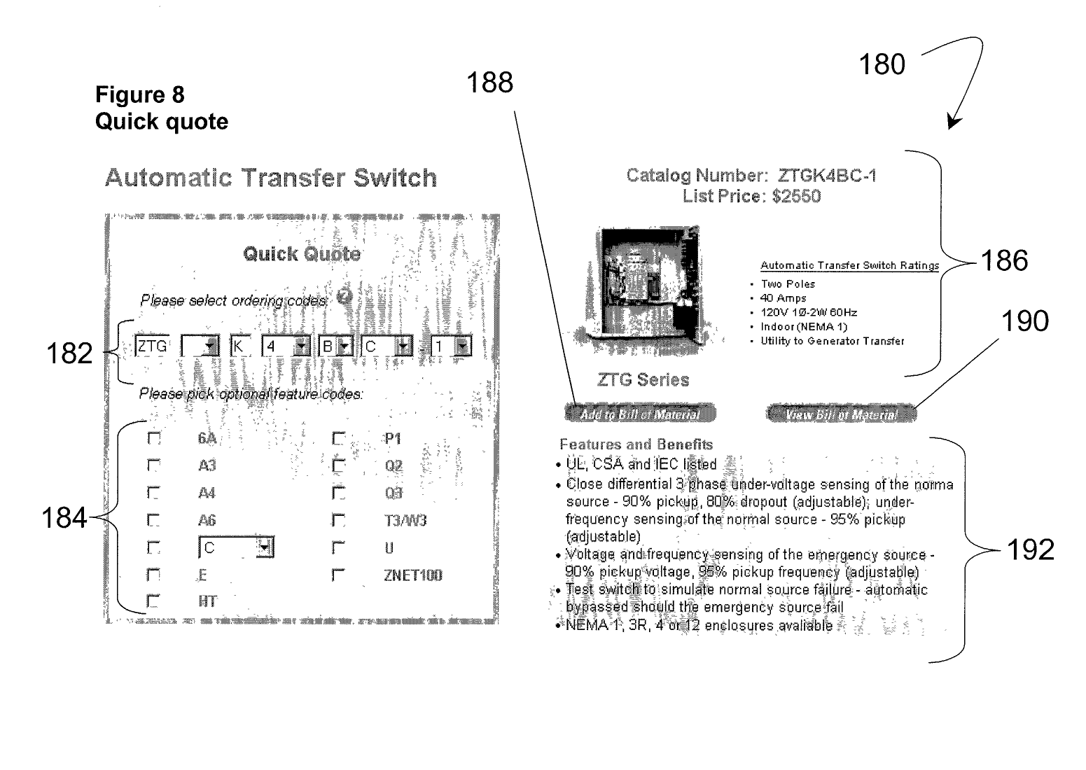

FIG. 8 shows an exemplary embodiment of an Automatic Transfer Switch quick quote page for pre-engineered swtiches for industrial/commercial use, as depicted in screen shot 180. Screen shot 180 includes an order code selection area 182, and an optional feature code selection area 184 for specifying a product and its associated options. Screen shot 180 also includes a recommendation area 186 that specifies further information about the recommended product that in one embodiment includes its catalog number and list price. Screen shot 180 also includes an Add to Bill of Material radio button 188, and a View Bill of Material radio button 190, as well as a Features and Benefits display area 192.

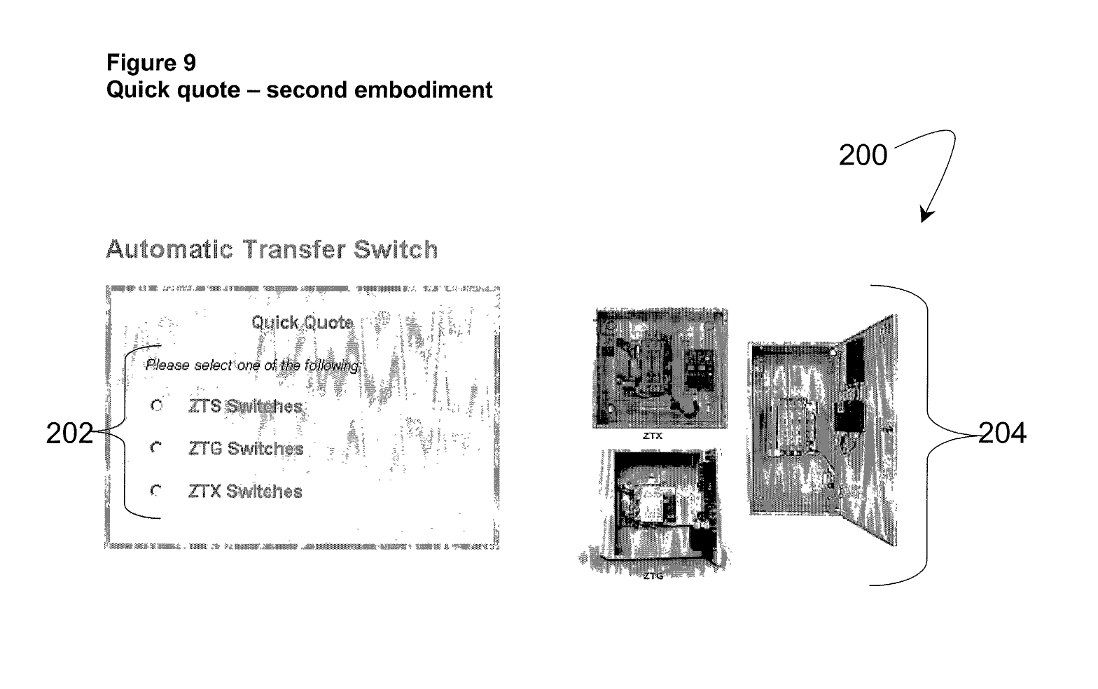

FIG. 9 shows a second exemplary embodiment of an Automatic Transfer Switch quick quote page, in this case for a customized and heavy-duty automatic transfer switch, as depicted screen shot 200. Screen shot 200 includes a Quick Quote selection area 202 for specifying a type of switch, and also includes a display area 204 with images of the types of switches listed in selection area 202.

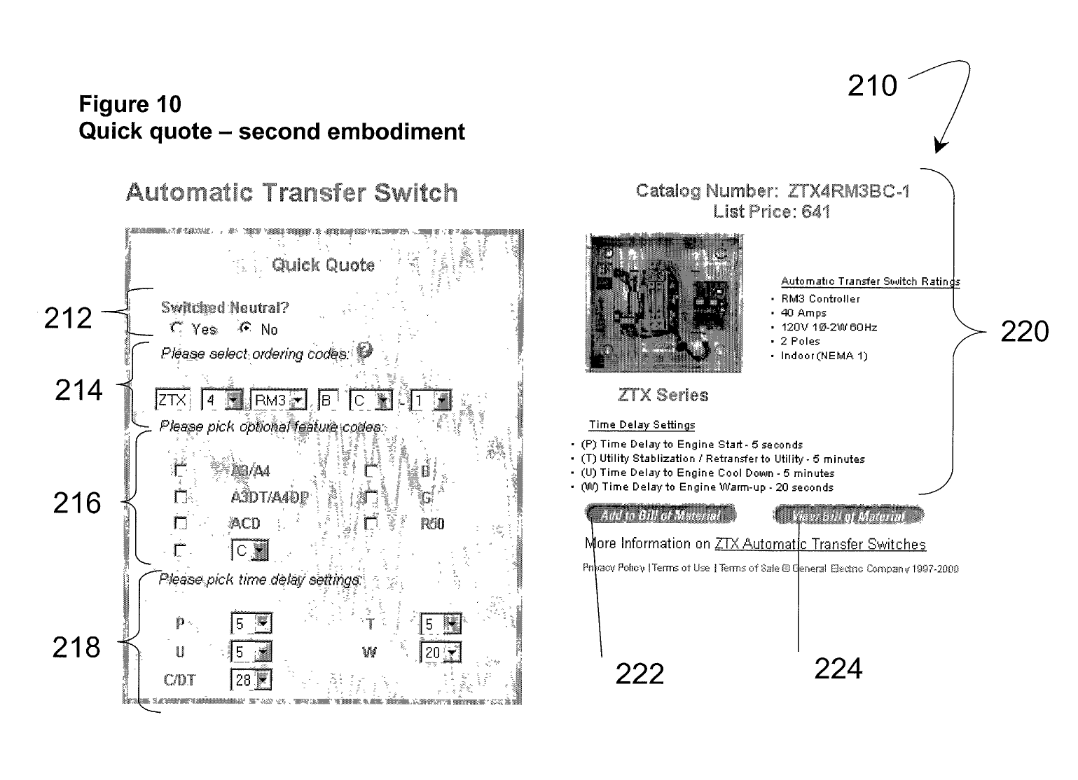

FIG. 10 is an exemplary embodiment of an Automatic Transfer Switch Residential/Commercial Light Use basic requirements page, as depicted screen shot 210, which includes a Switched Neutral? selection area 212, an order code selection area 214 containing a plurality of pull down menus, an optional feature code selection area 216 that contains a plurality of check boxes and pull down menus, and a time delay settings selection area 218 that contains a plurality of pull down menus. Screen shot 210 also includes a recommendation area 220 that in one embodiment includes a catalog number and list price for a recommended product. Screen shot 210 also includes an Add to Bill of Material radio button 222, and a View Bill of Material radio button 224.

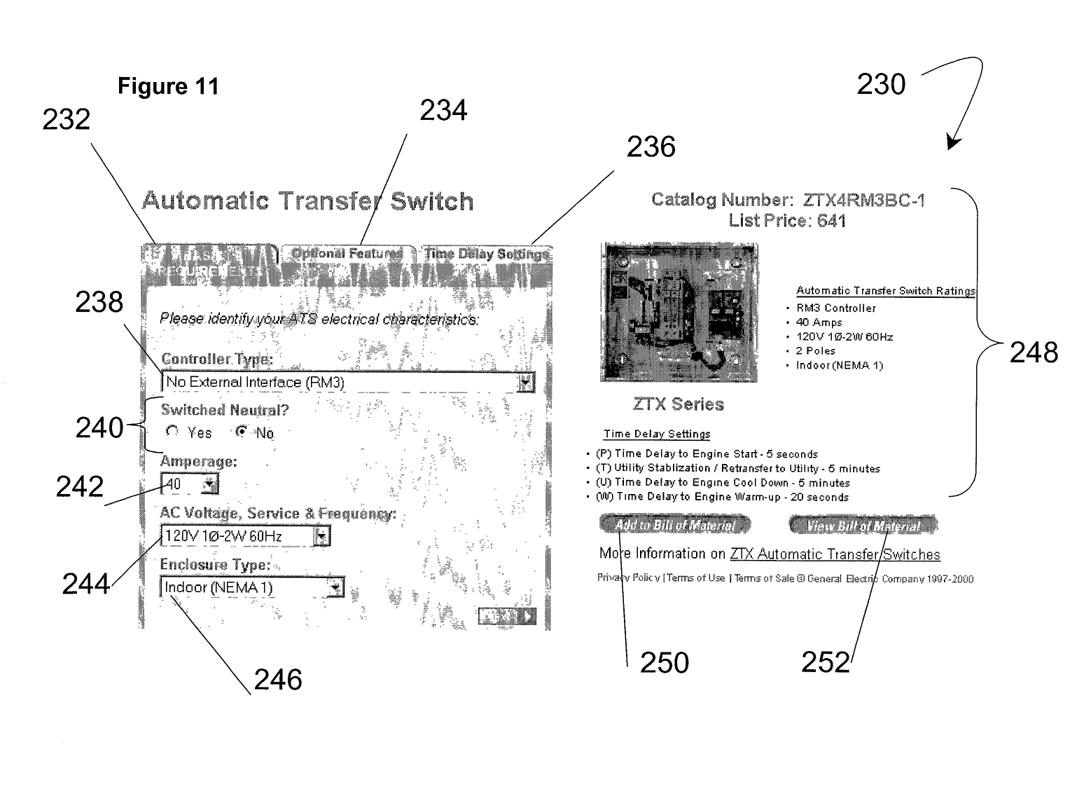

FIG. 11 is an exemplary embodiment of a an Automatic Transfer Switch Residential/Commercial Light Use basic requirements page, as depicted in screen shot 230, which includes a Basic Requirements tab 232, an Optional Features tab 234, and a Time Delay Settings tab 236. Screen shot 230 results from selection of Basic Requirements tab 232, and includes a Controller Type pull down menu 238, a Switched Neutral? Selection area 240, an Amperage pull down menu 242, an AC Voltage, Service & Frequency pull down menu 244, and an Enclosure Type pull down menu 246. Screen shot 230 also includes a recommendation area 248, that in one embodiment includes a catalog number and list price for a recommended product. Screen shot 230 also includes an Add to Bill of Material radio button 250 and a View Bill of Material radio button 252.

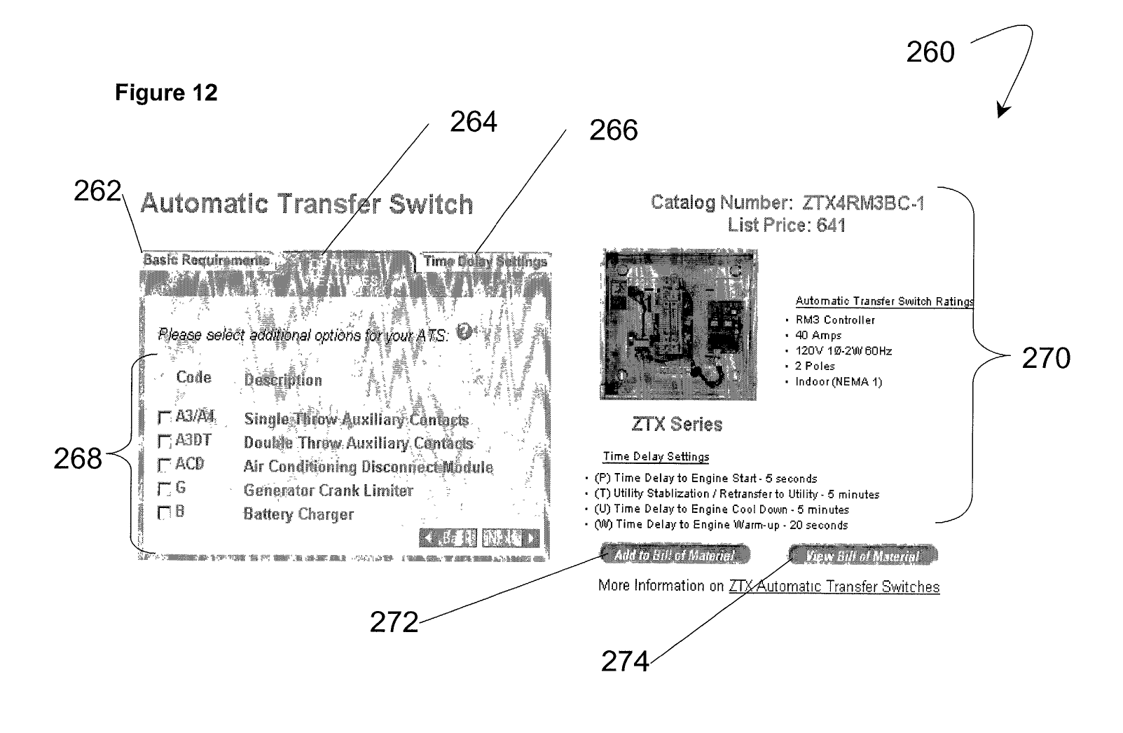

FIG. 12 is an exemplary embodiment of an Automatic Transfer Switch Residential/Commercial Light Use optional features page, as depicted in screen shot 260, which includes a Basic Requirements tab 262, an Optional Features tab 264, and a Time Delay Settings tab 266. Screen shot 260 results from selection of Optional Features tab 264, and includes an additional options selection area 268, and a recommendation area 270, that in one embodiment includes a catalog number and a list price. Screen shot 260 also includes an Add to Bill of Material radio button 272, and a View Bill of Material radio button 274.

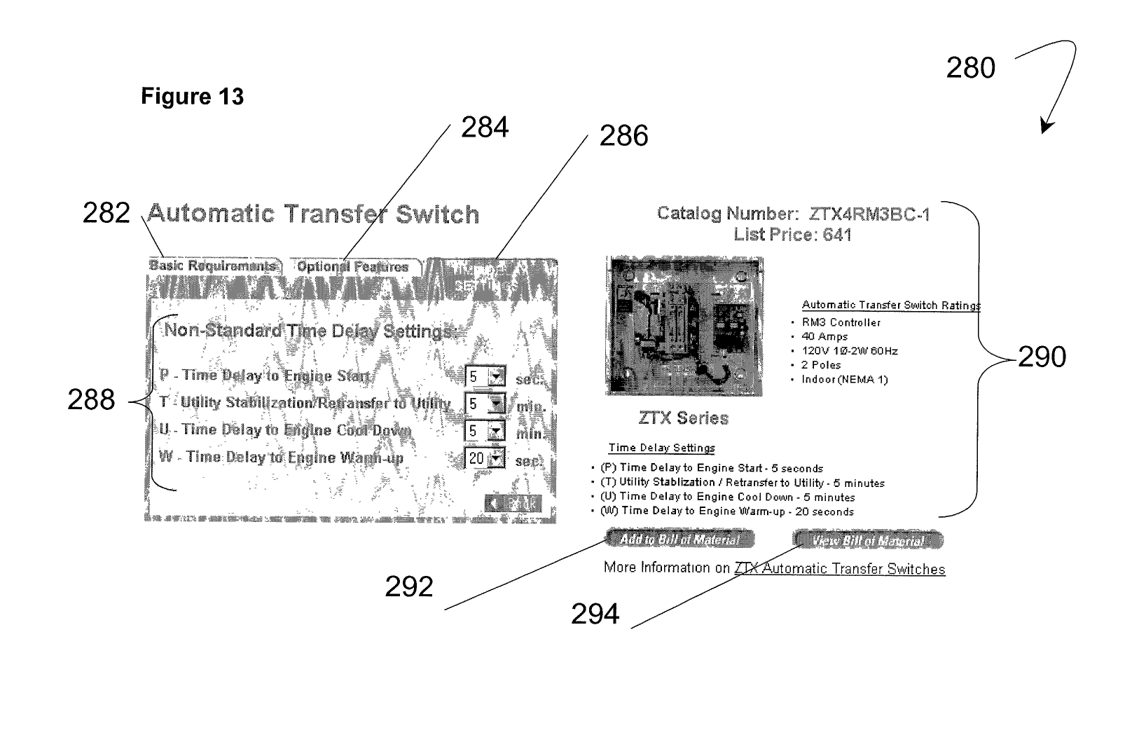

FIG. 13 is an exemplary embodiment of an Automatic Transfer Switch Residential/Commercial Light Use time delay settings page, as depicted in screen shot 280, which includes a Basic Requirements tab 282, an Optional Features tab 284, and a Time Delay Settings tab 286. Screen shot 280 results from selection of Time Delay Settings tab 286, and includes a Nonstandard Time Delay Settings selection area 288 that includes a plurality of pull down menus, and a recommendation area 290, that in one embodiment includes a catalog number and a list price. Screen shot 280 also includes an Add to Bill of Material radio button 292, and a View Bill of Material radio button 294.

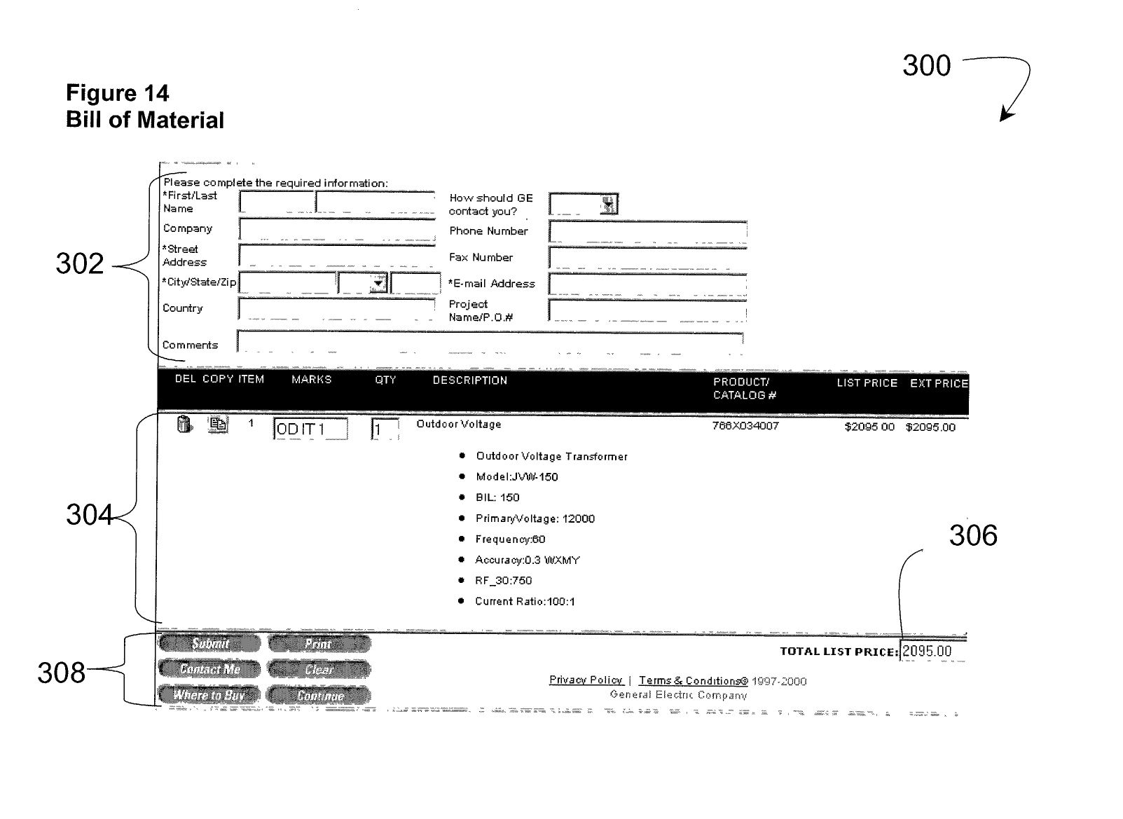

FIG. 14 is an exemplary embodiment of a Bill of Material page, as depicted in screen shot 300, that is downloaded and displayed by server system 12 when the user has selected “View Bill of Material” button 150 (shown in FIG. 6). Screen shot 300 includes a customer information area 302 where a user can specify contact information. Screen shot 300 also includes an order area 304 to display information about the order, including in one embodiment a specification of an item ordered, the quantity, description, catalog number, and price. Screen shot 300 further includes a List Price text box 306 that displays a total price of all items ordered. Screen shot 300 still further includes a set of radio buttons 308 that allow the user to submit the order, print the order, clear the bill of material, request that the user be contacted, find out where to buy the product, or continue.

In use, system 10 (shown in FIG. 1) provides the user with a complete automatic transfer switch configured to meet the user's needs. The user selects the rating of the automatic transfer switch, including power system rating, voltage rating, design requirements, number of poles, application, enclosure type, and any optional features. Based on these inputs system 10 displays the individual equipment prices and the total list price of the individual components. System 10 does not allow the user to configure a selection that is invalid and guides the user by informing the user why the selected configuation is invalid. Once the customer has configured the product, the user can add it to the user's bill of materials and then view the bill of materials, which the user can optionally print, or submit as an order.

While the invention has been described in terms of various specific embodiments, those skilled in the art will recognize that the invention can be practiced with modification within the spirit and scope of the claims.

What is claimed is:

1. A method for facilitating selection of an automatic transfer switch through use of a network-based system including a server and at least one device connected to the server via a network, said method comprising the steps of:
receiving product specification information from a user via the device;
comparing the received product specification information with prestored automatic transfer switch information;
selecting at least one automatic transfer switch that matches the received product specification information; and
displaying the information related to the automatic transfer switch.

2. A method according to claim 1 wherein said step of comparing the received product specification information comprises the steps of:
determining whether the features selected are available for the selected automatic transfer switch configuration; and
displaying a message if the selected features are not available for the selected automatic transfer switch configuration.

3. A method according to claim 1 wherein said step of receiving product information data from a user further comprises the step of receiving an identification for the product.

4. A method according to claim 1 wherein said step of displaying information related to the automatic transfer switch comprises the step of displaying the features selected for the automatic transfer switch

5. A method according to claim 1 wherein said step of displaying information related to the automatic transfer switch comprises the step of displaying the accessories selected for the automatic transfer switch.

6. A method according to claim 1 wherein said step of displaying information related to the automatic transfer switch comprises the step of displaying a catalog number and a list price for the automatic transfer switch.

7. A method according to claim 1 wherein said step of displaying information further comprises the step of generating a quotation for the automatic transfer switch.

8. A method according to claim 1 wherein said step of displaying information related to the automatic transfer switch comprises the step of displaying the dimensions of the automatic transfer switch.

9. A method according to claim 1 wherein the product specification information is received from the user via a graphical user interface.

10. A method according to claim 1 further comprising the step of assessing a need of the user based on at least one of a product application, product parameters, desired product features, and product accessories.

11. A method according to claim 1 further comprising the step of validating configuration compatibility based on the received product specification information to determine whether a resulting automatic transfer switch having the received product specifications is capable of meeting parameters of the product.

12. A method according to claim 14 further comprising the step of guiding the user, if the resulting product does not meet the parameters of the product, to a correct product configuration.

13. A method according to claim 11 further comprising the step of guiding the user to a compatible product.

14. A system for facilitating selection of an automatic transfer switch, said system comprising:
a device; and
a server connected to said device and configured to receive product specification information data from a user via said device, said server further configured to:
compare the received product specification information with pre-stored automatic transfer switch information;
select at least one automatic transfer switch from the pre-stored automatic transfer switch information based on automatic transfer switch identification criteria entered by the user; and
display information related to the automatic transfer switch based on the automatic transfer switch identification criteria.

15. A system according to claim 14 wherein said server further configured to download to the user the information related to the automatic transfer switch.

16. A system according to claim 14 wherein said server further configured to:
determine whether the features selected are available for the selected automatic transfer switch configuration; and
display a message if the selected features are not available for the selected automatic transfer switch configuration.

17. A system according to claim 14 wherein said server further configured to receive an identification for the product.

18. A system according to claim 14 wherein said server further configured to display the dimensions of the automatic transfer switch.

19. A system according to claim 14 wherein said server further configured to display the accessories selected for the automatic transfer switch.

20. A system according to claim 14 wherein said server further configured to:
determine whether the features selected are available for the selected automatic transfer switch configuration; and
display a message if the selected features are not available for the selected automatic transfer switch configuration.

21. A system according to claim 14 wherein said server further configured to receive an identification for the product.

22. A system according to claim 14 wherein said server further configured to display the features selected for the automatic transfer switch.

23. A system according to claim 14 wherein said server further configured to display the dimensions of the automatic transfer switch.

24. A system according to claim 14 wherein said server further configured to display the accessories selected for the automatic transfer switch.

25. A system according to claim 14 wherein said server further configured to display a catalog number and a list price for the automatic transfer switch.

26. A system according to claim 14 wherein said server further configured to generate a quotation for the automatic transfer switch.

27. A system according to claim 14 wherein said server further configured to receive the product specification information from the user via a graphical user interface.

28. A system according to claim 14 wherein said server further configured to assess a need of the user based on at least one of a product application, product parameters, desired product features, and product accessories.

29. A system according to claim 28 wherein said server further configured to validate configuration compatibility based on the received product specification information to determine whether a resulting automatic transfer switch having the received product specifications is capable of meeting parameters of the product.

30. A system according to claim 29 wherein said server further configured to guide the user, if the resulting product does not meet the parameters of the product, to a correct product configuration.

31. A system according to claim 30 wherein said server further configured to guide the user to a compatible product.

32. A system according to claim 14 wherein said server further configured to accept a purchase order for the automatic transfer switch after the purchase order has been authenticated against pre-determined criteria.

33. A system according to claim 14 wherein said device configured to be a server for a network of customer devices.

34. A system according to claim 14 wherein said server and said device are connected via a network.

35. A system according to claim 34 wherein said network is one of a wide area network, a local area network and the Internet.
